(19) United States
(12) Patent Application Publication
(10) Pub. No.: US 2003/0139941 A1
(43) Pub. Date: Jul. 24, 2003

(54) Vehicle boarding fare modification method based on boarding ratio calculated with operating state information of vehicles

(76) Inventor: Manabu Matsumoto, Handa-City (JP)

Correspondence Address: HARNESS, DICKEY & PIERCE, P.L.C., P.O. BOX 828, BLOOMFIELD HILLS, MI, 48303, US

(21) Appl. No.: 10/346,441

(22) Filed: Jan. 17, 2003

(30) Foreign Application Priority Data
Jan. 21, 2002 (JP) 2002-011441

(51) Int. Cl. G06F 17/60

(52) U.S. Cl. 705/1; 705/417

(57) ABSTRACT

A control center calculates boarding ratio based on operating state information (‘out-of-service,’ ‘empty,’ ‘pickup,’ and ‘serving’) that is received from taxis. It then determines whether the boarding ratio is less than a predetermined ratio. If the boarding ratio is less than the predetermined ratio, the control center notifies discount information for starting of discount operation where a taxi fare is reduced from a normal fare, to the taxis, a taxi stand, and a website on the internet. Notification of the discount information to general public enhances intension that the general public would like to take the taxis. The taxi company and taxi driver can thus expect increase of taxi customers.

### CROSS REFERENCE TO RELATED APPLICATIONS

This application is based on and incorporates herein by reference Japanese Patent Application No. 2002-11441 filed on Jan. 21, 2002.

### FIELD OF THE INVENTION

The present invention relates to a vehicle boarding fare modification method, a vehicle boarding fare modification system, vehicle-located equipment, stand-located equipment, and center-located equipment applied to a service industry where a customer pays a vehicle boarding fare for boarding one of a plurality of vehicles. In particular, the vehicle boarding fare is modified based on a boarding ratio calculated with operating state information received from the plurality of the vehicles.

### BACKGROUND OF THE INVENTION

A taxi is equipped with a global positioning system (GPS) receiver and transmits, to a control center, operating state information such as ‘out-of-service,’ ‘empty,’ ‘pick-up’ or ‘serving’ with current position information received from the GPS receiver. The control center analyses the operating state information and current position information received by the taxi. The control center can thereby comprehend overall vehicle operations and efficiently dispose the nearest taxi to a desired location when a request for providing a taxi is received from a customer.

Practically, taxis are sometimes awaiting customers for a few hours, for instance, at a taxi stand in front of stations according to weather or time of a day, for instance, in a sunny daytime when people prefers walking to taking the taxi. This situation is not efficient and not desired by a taxi company or a crewman (taxi driver) since operational profit is not obtained.

### SUMMARY OF THE INVENTION

It is an object of the present invention to provide a vehicle boarding fare modification method, a vehicle boarding fare modification system, vehicle-located equipment, stand-located equipment, and center-located equipment, all of which are applied to a service industry where a customer pays a vehicle boarding fare for boarding a vehicle in order for an operating company and a crewman to efficiently operate to obtain profits each other.

To achieve above and other objects, a modification method of a vehicle boarding fare is provided as follows. Boarding ratio is calculated based on operating state information that is received from the vehicles. When the boarding ratio becomes less than a predetermined ratio, the boarding fare is reduced from a normal fare and simultaneously reduction information expressing that the boarding fare is modified to be reduced from the normal fare is notified to general public who are not in the vehicles. Reduction operation is executed according to the modified boarding fare.

It is preferable that certification information, which certificates the reduction information, is issued to a customer who is going to board the vehicle. Accordingly, even when a crewman does not recognize the reduction information, the customer who is going to board the vehicle can, by submitting the issued certification information, resolve recognition difference with the crewman.

It is further preferable that the certification information is authenticated. When the certification information is rightly authenticated, the reduction operation is executed according to the modified boarding fare. Accordingly, even when the customer prepares unjust certification information, the crewman can prevent loss by the abuse of the unjust certification information.

The above structure enhances intention of the general public to want to board the vehicle and enables an operation company and a crewman to expect increase of customers. By contrast, the customers pay the reduced boarding fare and thereby obtain profit of reduction.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing an embodiment of the present invention;

FIG. 2 is a schematic diagram showing an overall structure of a system;

FIG. 3 is a schematic diagram showing a structure of taxi-located equipment;

FIG. 4 is a schematic diagram showing a structure of center-located equipment;

FIG. 5 is a schematic diagram showing a structure of stand-located equipment;

FIG. 6 is a flowchart diagram showing operating state transmission from taxi-located equipment to center-located equipment;

FIG. 7 is a flowchart diagram showing operating state transmission from taxi-located equipment to stand-located equipment;

FIG. 8 is a flowchart diagram showing discount information transmission from a control center to taxi-located equipment;

FIG. 9 is a flowchart diagram showing discount information transmission from a stand to taxi-located equipment;.

FIG. 10 is a perspective view of a taxi;

FIG. 11 is a perspective view of stand-located equipment with a display;

FIG. 12 is a perspective view of stand-located equipment with another display;

FIG. 13 is a window view of a website on the Internet;

FIGS. 14A to 14D are diagrammatic views showing notifying methods of discount operation;

FIG. 15A is a diagram showing sequence in which certification information is stored in an IC card;

FIG. 15B is a diagram showing sequence in which the certification information stored in the IC card is authenticated;

FIG. 16A is a diagram showing sequence in which certification information is stored in a cell phone;

FIG. 16B is a diagram showing sequence in which the certification information stored in the cell phone is authenticated;

FIG. 17 is a first display view of center-located equipment;

FIG. 18 is a second display view of center-located equipment; and

FIG. 19 is a third display view of center-located equipment.

### DETAILED DESCRIPTION OF THE PREFERRED EMBODIMENTS

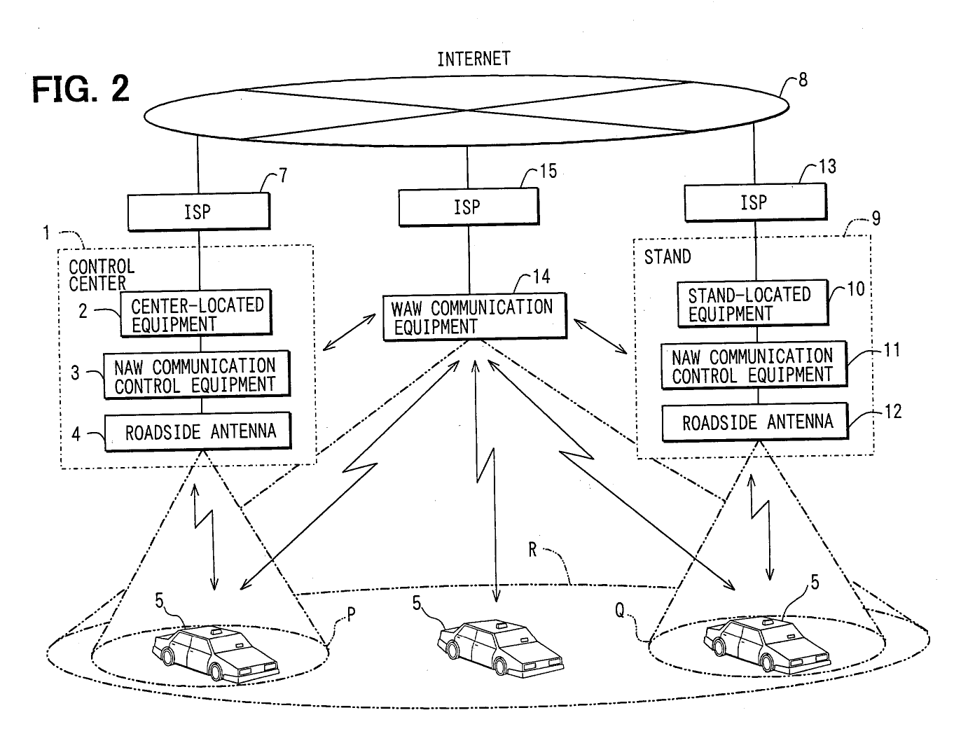

An embodiment of the present invention is applied to taxi business industry. At first, referring to FIG. 2, a control center 1 is equipped with equipment installed in the control center 1 (center-located equipment) 2, narrow area wireless (NAW) communication control equipment 3, and a roadside antenna 4. As specifically explained below, the center-located equipment 2 calculates boarding ratio of taxis 5 and determine whether discount operation (equivalent to reduction operation) is executed.

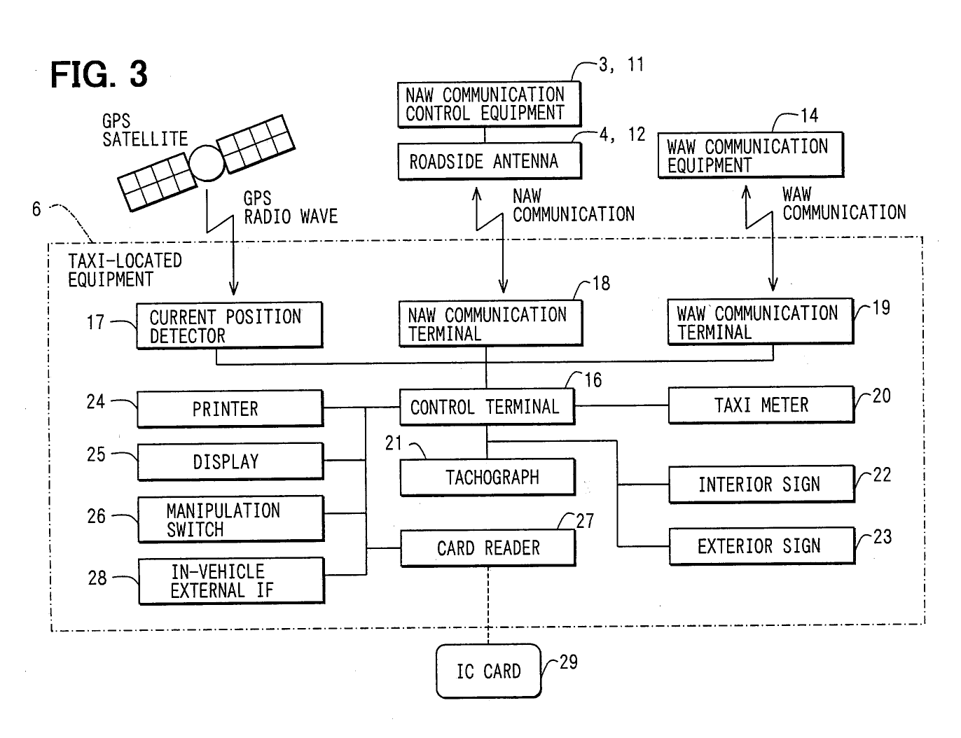

The NAW communication control equipment 3 forms a predetermined NAW communication area (area surrounded by two-dot chain Line P in FIG. 2) with the roadside antenna 4 according to NAW communication, for instance, compliant with dedicated short range communication (DSRC). When a taxi 5 stands or runs within the predetermined NAW communication area, the NAW communication control equipment 3 communicates with equipment installed in the taxi 5 (taxi-located equipment) 6 (see FIG. 3) through the NAW communication. In addition, the NAW communication includes not only the DSRC but also a local area network (wireless LAN) compliant with institute of electrical and electronic engineers (IEEE) 802.11b, Bluetooth communication (Bluetooth is a registered trade mark), or infrared communication.

The center-located equipment 2 communicates with the Internet 8 via an internet service provider (ISP) 7.

A stand 9, located in front of stations or facilities, is a waiting area where customers are waiting for the taxi 5 to take. In the stand 9, equipment installed in the stand 9 (stand-located equipment) 10, NAW communication control equipment 11, and a roadside antenna 12 are installed. The stand-located equipment 10, as specifically explained below, displays discount operation when the center-located equipment 2 determines execution of the discount operation.

The NAW communication control equipment 11, similarly to the NAW communication equipment 3 installed in the control center 1, forms a predetermined NAW communication area (area surrounded by two-dot chain Line Q in FIG. 2) with the roadside antenna 12. When a taxi 5 stands or runs within the predetermined NAW communication area, the NAW communication control equipment 11 communicates with taxi-located equipment 6 through the NAW communication.

The stand-located equipment 10 also communicates with the Internet 8 via the ISP 13.

Wide area wireless (WAW) communication equipment 14 includes cell phone network (including base stations and base station control devices) provided by a cell phone service provider. The WAW communication equipment 14 forms a predetermined WAW communication area (area surrounded by two-dot chain Line R in FIG. 2). When a taxi 5 stands or runs within the predetermined WAW communication area, the WAW communication control equipment 14 communicates with taxi-located equipment 6 through the WAW communication. In addition, the WAW communication equipment 14 includes not only the cell phone network provided by the cell phone service provider but also a personal handy phone communication using a personal handy phone communication system network, or business-purposed wireless communication. The WAW communication equipment 14 also communicates with the Internet 8 via the ISP 15.

The center-located equipment 2 can communicate with the stand-located equipment 10 through the WAW communication or the Internet communication. The center-located equipment 2 can also communicate with the taxi-located equipment 6 through the WAW communication or the NAW communication in the control center 1 or the stand 9. The center-located equipment 2 can thus transmit or receive operating state or discount information, both of which are described below, with the taxi-located equipment 6.

Referring to FIG. 3, the taxi-located equipment 6 includes the following: a control terminal 16; a current position detector 17; NAW communication terminal 18; WAW communication terminal 19; a taxi meter 20; a tachograph 21; an interior sign 22; an exterior sign 23; a printer 24; a display 25; a manipulation switch 26; a card reader 27; and in-vehicle interfaces (IF).

The control terminal 16 controls each device along with authenticating certification information stored in an IC card 29. The current position detector 17 demodulates global positioning system (GPS) signals from GPS satellites to detect the current position of the taxi 5. The NAW communication terminal 18 communicates with the NAW communication equipment 3, 11. The WAW communication terminal 19 communicates with the above WAW communication equipment 14. The taxi meter 20 calculates business-related numerals such as a boarding fare or a driving mileage. The tachograph 21 stores vehicle speed, time, and others.

The interior sign 22 is disposed at an in-vehicle dashboard to be viewed from the outside of the vehicle. When the taxi 5 cannot accept a customer irrespective of no passenger, the interior sign 22 displays ‘out-of-service.’ When the taxi 5 can accept a customer, the interior sign 22 displays ‘empty.’ When the taxi 5 is going to pick up a customer, the interior sign 22 displays ‘pick-up.’ When the taxi 5 has a passenger, the interior sign 22 displays ‘serving.’ In addition, when the taxi 5 operates extra-fared service, for instance, in nighttime, the interior sign 22 displays ‘extra.’ When the taxi 5 operates discounted-fared service that is featured in the invention, the interior sign 22 displays ‘discount.’ Furthermore, when the taxi 5 operates fixed-fared service, the interior sign 22 also displays ‘fixed.’ The display of the interior sign 22 is switched according to a command signal received from the control center 1, manipulation of the manipulating button 26 by the driver, or function of time scheduling.

The exterior sign 23 is generally disposed on a roof of the taxi 5. Similarly to the interior sign 22, when the taxi 5 operates extra-fared service, the exterior sign 23 displays ‘extra.’ When the taxi 5 operates discounted-fared service, the interior sign 23 displays ‘discount.’ Furthermore, when the taxi 5 operates fixed-fared service, the exterior sign 23 also displays ‘fixed.’ The display of the interior sign 23 is also switched according to a command signal received from the control center 1, manipulation of the manipulating button 26 by the driver, or function of time scheduling.

The printer 24 issues, for instance, a receipt that certifies a boarding fare according to a customer request. The display 25 is disposed to be seen from the driver or the passenger with displaying the above boarding fare calculated by the taxi meter 20 and others. The manipulation button 26 is used for switching, in the interior sign 22, the displays, ‘out-of-service,’ ‘empty,’ ‘pick-up,’ and ‘serving,’ or displays, ‘extra,’ ‘discount,’ and ‘fixed.’ It also switches the ‘extra,’ ‘discount,’ and ‘fixed’ in the exterior sign 23.

The card reader 27, specifically as explained below, reads out certification information to certificate when the IC card 29 storing the certification information is inserted.

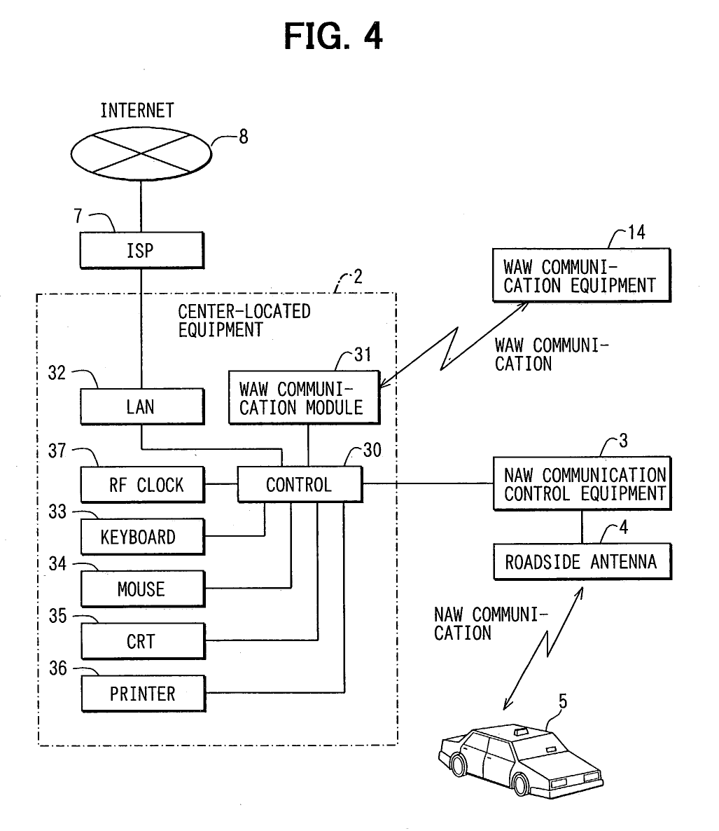

Referring to FIG. 4, the center-located equipment 2 includes well-known computer terminals where a control 30 is connected with a WAW module 31, a LAN 32, a keyboard 33 and mouse 34 as input instruments, a cathode ray tube (CRT) 35, a printer 36, and a radio frequency (RF) clock 37.

The control 30 generally controls each part of the center-located equipment 2. The WAW module 31 communicates with the WAW equipment 14 explained above. The LAN 32 controls communication with the Internet 8. The keyboard 33 and mouse 34 are used for input operation. The CRT 35 and the printer 36 output the processing result by the control 30. The RF clock 37 receives a standard frequency broadcast including time information, so that internal time in the center-located equipment 2 is modified. The center-located equipment 2 can transmit the modified internal time to a clock (not shown) installed in the taxi 5.

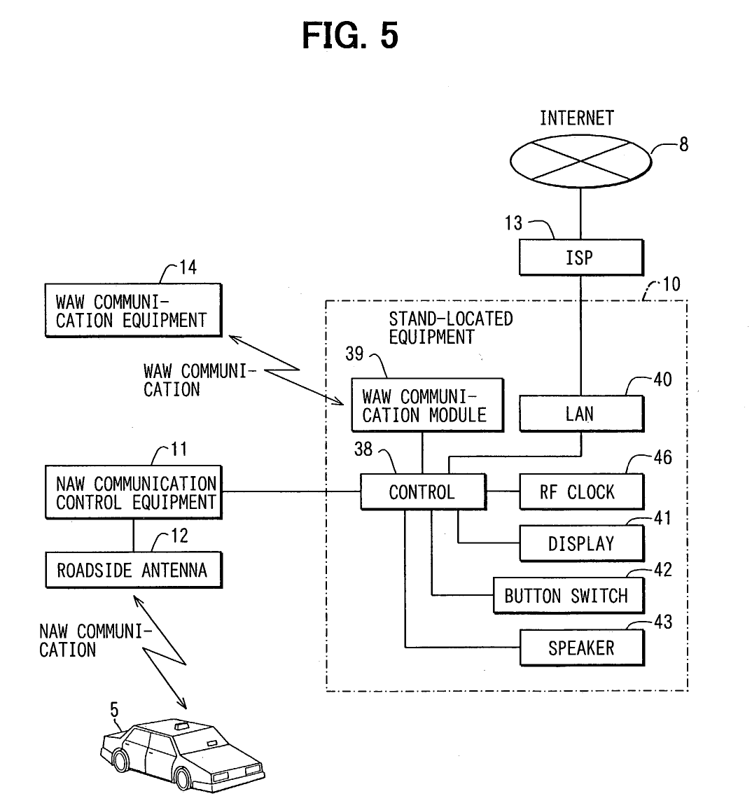

Referring to FIG. 5, the stand-located equipment 10 includes a control 38 which is connected with a WAW module 39, a LAN 40, a display 41 having a wide display area, a button switch 42, a speaker 43, and a RF clock 46.

The control 38 controls overall operation of each part of the stand-located equipment 10. The WAW module 39 communicates with the WAW equipment 14 explained above. The LAN 40 controls communication with the Internet 8. The display 41 displays the discount information when the center-located equipment 2 determines execution of the discount operation. The button switch 42 is used, for instance, when a customer requests a taxi 5. The speaker 43 is for voice guidance. The RF clock 46, similarly to the RF clock 37 installed in the center-located equipment 2, receives the standard frequency broadcast including the time information, so that internal time in the stand-located equipment 10 is modified.

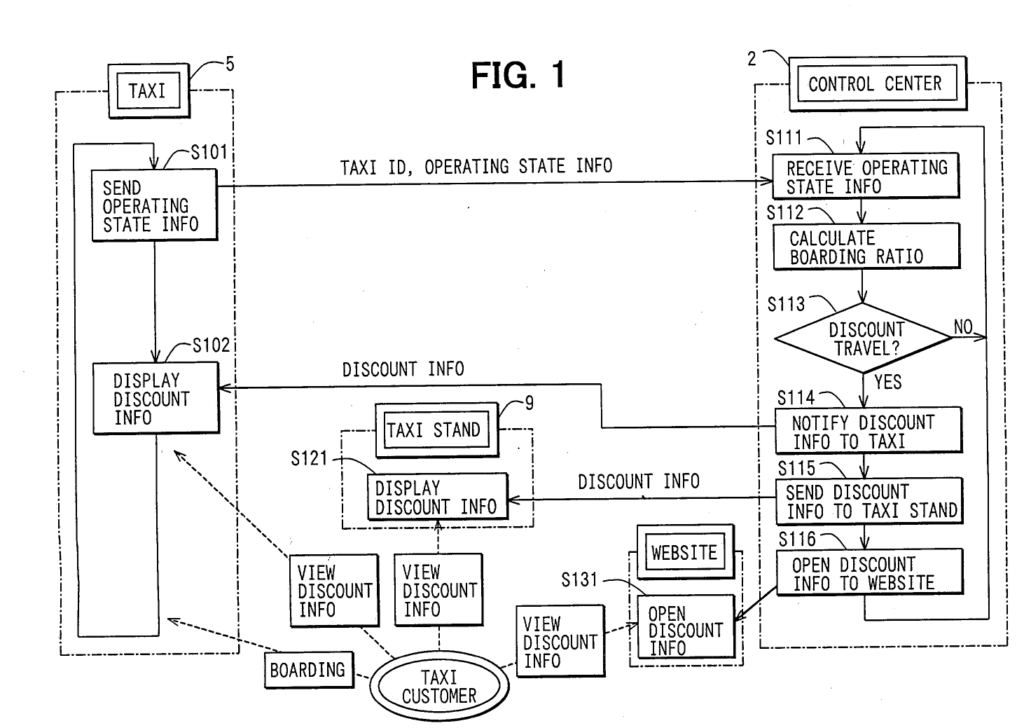

Operation of the above structure will be explained below, referring to FIGS. 1, 6, and 19. The taxi-located equipment 6 sends, to the center-located equipment 2, the operating state information expressing one of ‘out-of-service,’ ‘empty,’ ‘pick-up,’ and ‘serving.’ along with a taxi ID that is assigned for identifying the taxi 5 (Step 101 in FIG. 1). Here, the taxi-located equipment 6 sends a current position information detected by the current position detector 17 when needed.

There are manners in which the taxi-located equipment 6 sends the operating state information to the center-located equipment 2 as follows:

Manner (1): The taxi-located equipment 6 sends, in front of the control center 1, the operating state information to the center-located equipment 2.

Manner (2): The taxi-located equipment 6 sends the operating state information to the stand-located equipment 10, which then sends the operating state information to the center-located equipment 2.

Manner (3): The taxi-located equipment 6 sends the operating state information to the center-located equipment 2 through the WAW communication.

Each manner will be explained below.

Manner (1): The taxi-located equipment 6 sends, in front of the control center 1, the operating state information to the center-located equipment 2.

This manner corresponds to situation where the taxi 5 stands or runs in front of the control center 1.

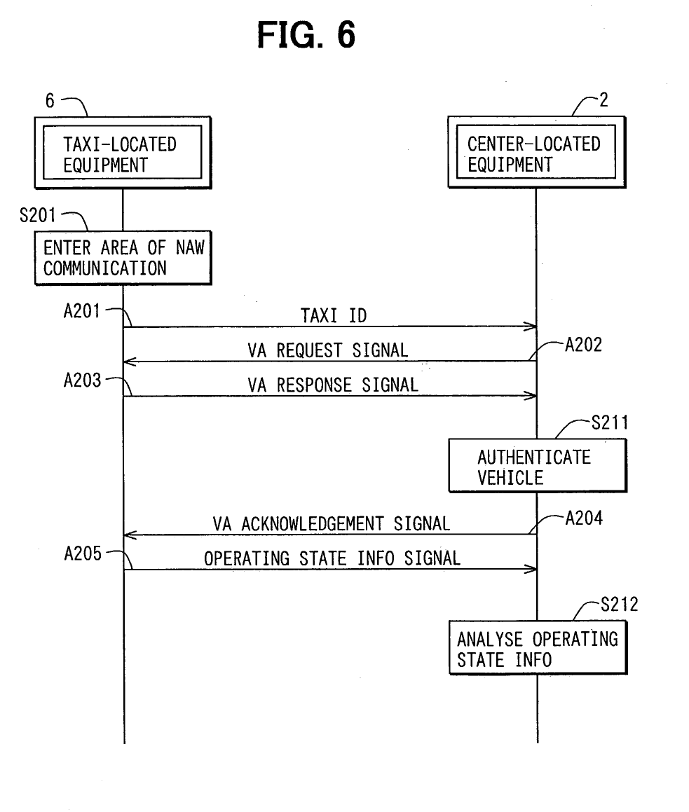

Referring to FIG. 6, as the taxi-located equipment 6 enters the NAW communication area formed by the roadside antenna 4 (Step 201), it sends a taxi ID to the center-located equipment 2 (A201). As the center-located equipment 2 receives the taxi ID, it sends a vehicle authentication (VA) request signal to the taxi-located equipment 6 for requesting authentication of the taxi 5 (A202).

As the taxi-located equipment 6 receives the VA request signal from the center-located equipment 2, it sends a VA response signal to the center-located equipment 2 (A203). As the center-located equipment 2 receives the VA response signal, it authenticates the taxi 5 based on the VA response signal (Step 211). The center-located equipment 2 sends to the taxi-located equipment 6 a VA acknowledgement signal when the taxi 5 is rightly authenticated (A204).

As the taxi-located equipment 6 receives the VA acknowledgement signal, it sends to the center-located equipment 2 operating state information of the taxi 5 expressing one of ‘out-of-service,’ ‘empty,’ ‘pick-up,’ and ‘serving’ (A205). As the center-located equipment 2 receives the operating state information signal, it analyses the operating state information included in the operating state information signal (Step 212).

The center-located equipment 2 can thus receive the operating state information from the taxi 5 to recognize the operating state of the taxi 5 through the NAW communication between the taxi-located equipment 6 and the NAW control equipment 3 when the taxi 5 stands or runs in front of the control center 1.

Manner (2): The taxi-located equipment 6 sends the operating state information to the stand-located equipment 10, which then sends the operating state information to the center-located equipment 2. This manner corresponds to situation where the taxi 5 stands or runs in front of the stand 9.

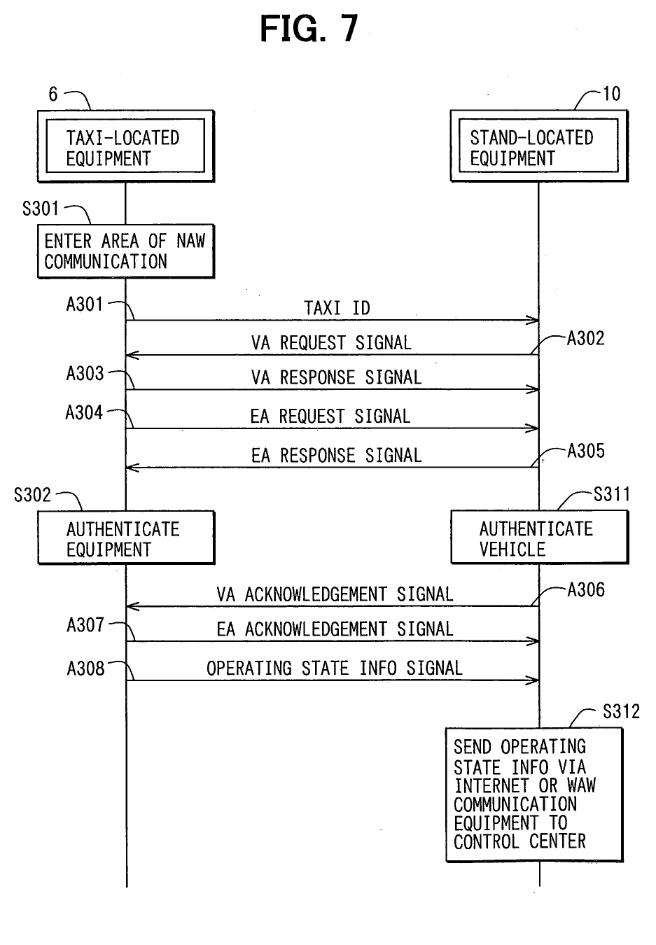

Referring to FIG. 7, as the taxi-located equipment 6 enters the NAW communication area formed by the roadside antenna 12 (Step 301), it sends a taxi ID to the stand-located equipment 10 (at A301). As the stand-located equipment 10 receives the taxi ID, it sends a vehicle authentication (VA) request signal to the taxi-located equipment 6 for requesting authentication of the taxi 5 (A302).

As the taxi-located equipment 6 receives the VA request signal, it sends to the stand-located equipment 10 a VA response signal (A303). It then sends to the stand-located equipment 10 an equipment authentication (EA) request signal for requesting authentication of the stand 9 (Step 304). The stand-located equipment 10 receives the VA response signal along with the EA request signal. The stand-located equipment 10 then sends an EA response signal to the taxi-located equipment 6 (A305), and it authenticates the taxi 5 based on the VA response signal (Step 311). As the taxi-located equipment 6 receives the EA response signal, it authenticates the stand 9 based on the EA response signal (Step 302).

The stand-located equipment 10 sends a VA acknowledgement signal to the taxi-located equipment 6 when the taxi 5 is rightly authenticated (A306). The taxi-located equipment 6 sends an EA acknowledgement signal to the stand-located equipment 10 when the stand 9 is rightly authenticated (A307). The taxi-located equipment 6 then sends operating state information to the stand-located equipment 10 (A 308).

As the stand-located equipment 10 receives the operating state information signal, it sends the operating state information to the center-located equipment 2 through the WAW equipment 14 or the Internet 8 (Step 312). As the center-located equipment 2 receives the operating state information through the WAW equipment 14 or the Internet 8, it analyses the operating state information included in the operating state information signal.

The center-located equipment 2 can thus receive the operating state information from the taxi 5 via the stand-located equipment 10 through the NAW communication, and the WAW communication or the Internet 8 when the taxi 5 stands or runs in front of the stand 9. In addition, the VA can be executed by the center-located equipment 2 instead of the stand-located equipment 10.

Manner (3): The taxi-located equipment 6 sends the operating state information to the center-located equipment 2 through the WAW communication.

This manner corresponds to situation where the taxi 5 stands or runs in a service area of the WAW equipment 14.

Here, the taxi-located equipment 6 establishes a communication link to communicate with the center-located equipment 2 through the WAW communication to send the operating state information. Here, the communication between the center-located equipment 2 and the taxi-located equipment 6 can be executed with or without the Internet communication. If the Internet communication is used, the communication is linked through the ISP 15, the Internet 8, the ISP 7, and the LAN module 32. In addition, the Internet communication is desired to adopt a secure socket layer (SSL) or hyper text transfer protocol security (HTTPS) to secure security. As the center-located equipment 2 receives the operating state information signal, it analyses the operating state information included in the operating state information signal.

As the center-located equipment 2 receives the operating state information from the taxi-located equipment 6 in the above manners (1), (2), and (3) (Step 111 in FIG. 1), it then calculates a boarding ratio (Step 112 in FIG. 1).

Here, the boarding ratio is calculated by the following formula:

‘Boarding ratio’=‘profit-expected vehicle number,’/‘operated vehicle number,’×100 (%).

‘Profit-expected vehicle number’ is the number of the taxis 5 whose operating state information is ‘pick-up’ or ‘serving.’ ‘Operated vehicle number’ is the number of the taxis 5 whose operating state information is ‘out-of-service,’ ‘empty,’ ‘pick-up,’ or ‘serving.’

Specifically, when ten taxis 5 are in the state of ‘out-of-service,’ twenty are in the state of ‘empty’, five are in the state of ‘pick-up,’ and fifteen are in the state of ‘serving,’

$$' Boarding ratio ' = ( 5 + 15 ) / ( 10 + 20 + 5 + 15 ) \times 100 ( \% ) = 40 ( \% ) .$$

In addition, the boarding ratio can be calculated in a different formula from the above formula.

The center-located equipment 2 compares the above calculated boarding ratio with a reference boarding ratio, so that it determines whether discount operation to discount a boarding fare is executed (Step 113 in FIG. 1). The reference boarding ratio can be constant during a day or flexible depending on a time zone of the day. It can be also constant during a month or flexible depending on a day of the month. Furthermore, it can be also constant during a year or flexible depending on a month of the year. The reference boarding ratio can be determined in consideration of operation costs such as a maintenance cost, fuel cost, and labor cost.

The center-located equipment 2 determines the discount operation when the boarding ratio becomes less than the reference boarding ratio (YES at Step 113 in FIG. 1). In this case, the center-located equipment 2 can determine the discount operation only after the boarding ratio has been less than the reference boarding ratio for a predetermined period. The centre-located equipment 2 can continue to execute the discount operation for a predetermined period even if the boarding ratio becomes not less than the reference boarding ratio. The center-located equipment 2 can alternate the reference boarding ratios for a shift from the normal fare to discount fare and a shift from the discount fare to the normal fare. This prevents frequent occurrence of the shifts between the normal fare and the discount fare, even if the boarding ratio fluctuates around the reference boarding ratio.

The center-located equipment 2 notifies the discount information expressing that the boarding fare is discounted. The center-located equipment 2 can also notify, along with an effect that the boarding fare is discounted, for instance, a discount ratio that is calculated based on the boarding ratio. In addition, a uniform discount ratio that is previously determined can be notified.

There are manners in which the center-located equipment 6 notifies the discount information as follows:

Manner (4): The center-located equipment 2 sends the discount information to the taxi-located equipment 6 (Step 114 in FIG. 1).

Manner (5): The center-located equipment 2 sends the discount information to the stand-located equipment 10 (Step 115 in FIG. 1).

Manner (6): The center-located equipment 2 notifies the discount information to open on the website on the Internet 8 (Step 116 in FIG. 1).

Each manner will be explained below.

Manner (4): The center-located equipment 2 sends the discount information to the taxi-located equipment 6.

This manner also includes the following manners:

Manner (4-1): The center-located equipment 2 sends the discount information to the taxi-located equipment 6 in front of the control center 1.

Manner (4-2): The center-located equipment 2 sends the discount information to the stand-located equipment 10, which then sends the discount information to the taxi-located equipment 6.

Manner (4-3): The center-located equipment 2 sends, through the WAW equipment 14, the discount information to the taxi-located equipment 6.

Each manner will be explained below.

Manner (4-1): The center-located equipment 2 sends the discount information to the taxi-located equipment 6 in front of the control center 1.

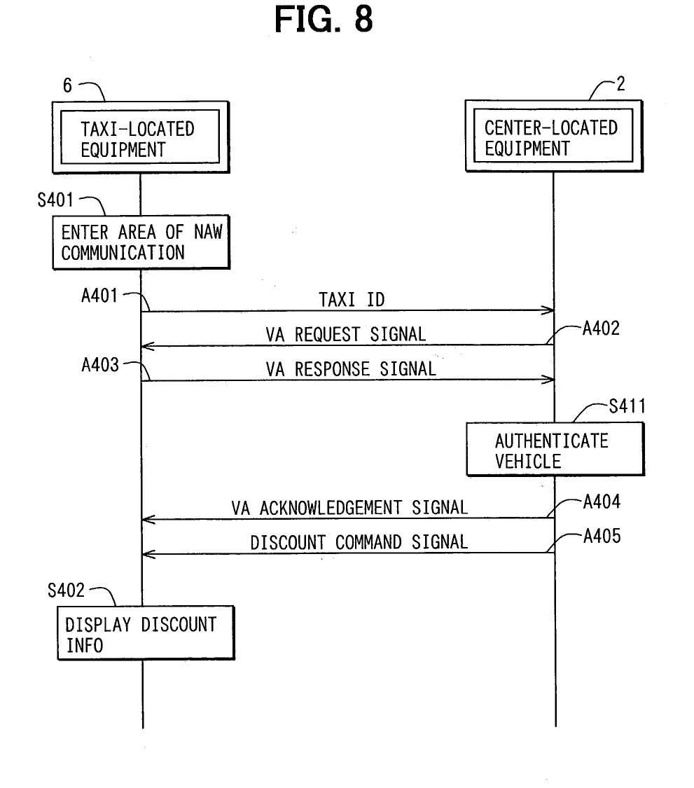

This manner corresponds to situation where the taxi 5 stands or runs in front of the control center 1. Referring to FIG. 8, the same processing is executed partway as that of Manner (1) explained in FIG. 6.

Namely, similarly to manner (1), as the taxi-located equipment 6 installed in the taxi 5 enters the NAW communication area formed by the roadside antenna 4 (Step 401), the taxi 5 is authenticated by the center-located equipment 2 through A401, A402, and A403 (Step 411). The center-located equipment 2 then sends to the taxi-located equipment 6 a VA acknowledgement signal when the taxi 5 is rightly authenticated (A404). It also sends a discount command signal including the discount information (A405).

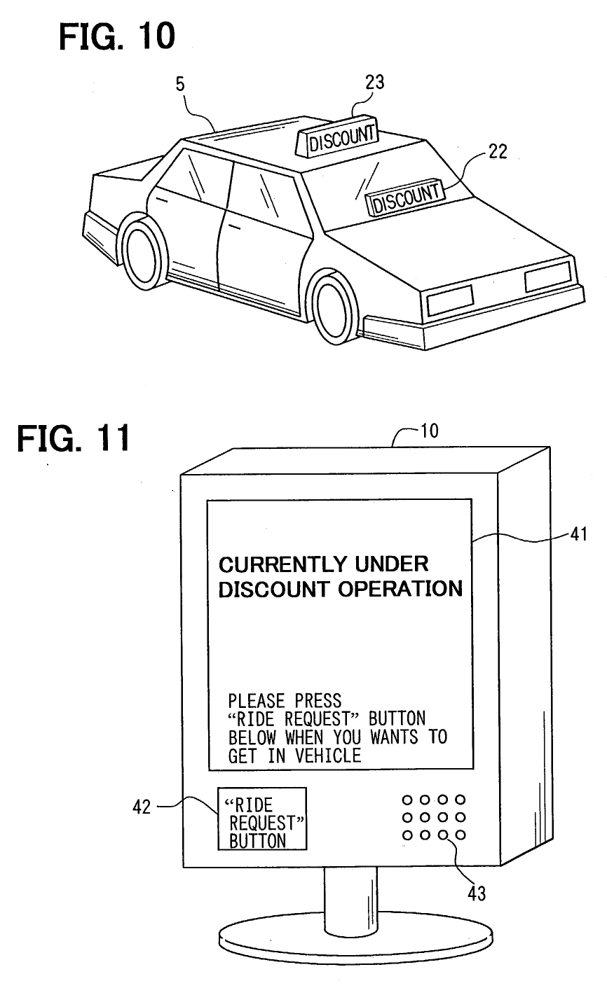

As the taxi-located equipment 6 receives the discount command signal, it displays ‘discount’ on the interior or exterior sign 22, 23 to notify the effect that the boarding fare is discounted as shown in FIG. 10 (Step 402, Step 102 in FIG. 1). Here, the interior or exterior sign 22, 23 can display ‘discount’ according to the reception of the discount command signal or manipulation of the manipulation button 26 by the driver.

The center-located equipment 2 can thus send the discount information to the taxi-located equipment 6 through the NAW communication between the taxi-located equipment 6 and the NAW control equipment 3 when the taxi 5 stands or runs in front of the control center 1.

Manner (4-2): The center-located equipment 2 sends the discount information to the stand-located equipment 10, which then notifies the discount information to the taxi-located equipment 6.

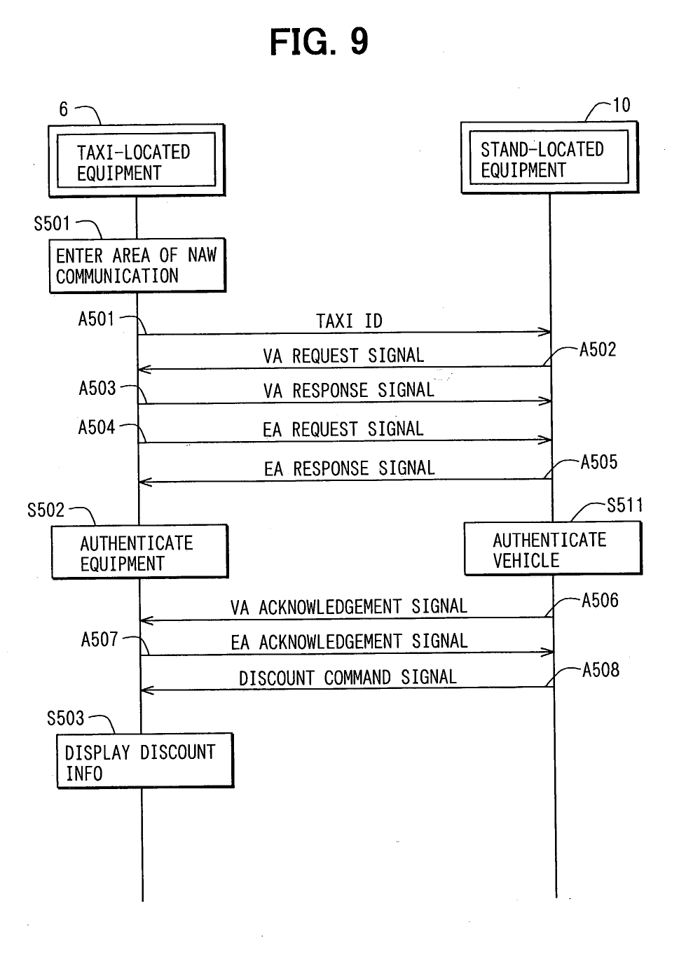

This manner corresponds to situation where the taxi 5 stands or runs in front of the stand 9. Referring to FIG. 9, the same processing is executed partway as that of Manner (2) explained in FIG. 7.

Namely, similarly to manner (2), as the taxi-located equipment 6 installed in the taxi 5 enters the NAW communication area formed by the roadside antenna 12 (Step 501), the taxi 5 or the stand 9 is authenticated by the stand-located equipment 10 or the taxi-located equipment 6, respectively, through A501, A502, A503, A504, and A505 (Steps 511 and 502).

The stand-located equipment 10 then sends to the taxi-located equipment 6 a VA acknowledgement signal when the taxi 5 is rightly authenticated (A506). The taxi-located equipment 6 sends to the stand-located equipment 10 an EA acknowledgement signal when the stand 9 is rightly authenticated (A507). The stand-located equipment 10 sends the discount command signal that has been already received from the center-located equipment 2 to the taxi-located equipment 6 (A508).

As the taxi-located equipment 6 receives the discount command signal, it also displays ‘discount’ on the interior or exterior sign 22, 23 to notify the effect that the boarding fare is discounted as shown in FIG. 10 (Step 503, Step 102 in FIG. 1).

The center-located equipment 2 can thus send the discount information to the taxi-located equipment 6 through the NAW communication, and the WAW communication or the Internet 8 when the taxi 5 stands or runs in front of the stand 9.

Manner (4-3): The center-located equipment 2 sends, through the WAW equipment 14, the discount information to the taxi-located equipment 6.

This manner corresponds to situation where the taxi 5 stands or runs in the service area of the WAW equipment 14.

In this case, the center-located equipment 2 establishes a communication link to communicate with the taxi-located equipment 6 through the WAW communication. After establishing the communication link, the center-located equipment 2 sends to the taxi-located equipment 6 a discount command signal including the discount information. As the taxi-located equipment 6 receives the discount command signal from the center-located equipment 2, it also displays ‘discount’ on the interior or exterior sign 22, 23 to notify-the effect that the boarding fare is discounted as shown in FIG. 10 (Step 102 in FIG. 1).

Manner (5): The center-located equipment 2 notifies the discount information to the stand-located equipment 10.

In this manner, the center-located equipment 2 sends the discount command signal to the stand-located equipment 10 through the WAW communication or the Internet communication. As the stand-located equipment 10 receives the discount command signal, it displays, on a display 41, a message, for instance, ‘currently under discount operation’ to notify the effect that the boarding fare is discounted (Step 121).

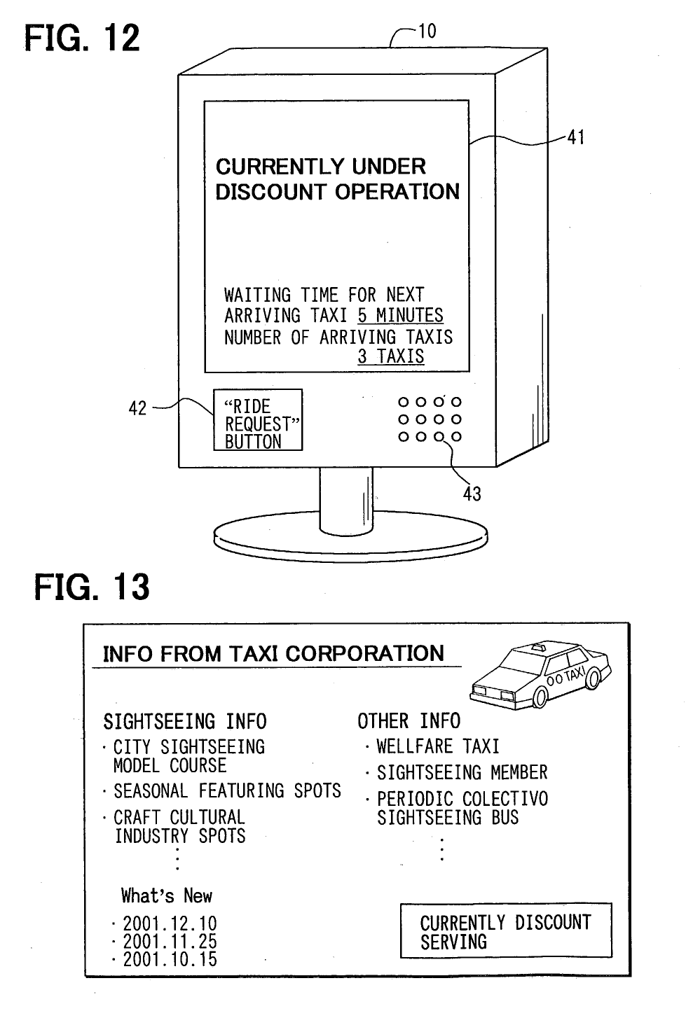

In addition, the center-located equipment 2 can calculate waiting time for a next arriving taxi 5 or the number of arriving taxis by recognizing current positions of taxis 5. The center-located equipment 2 can thereby send the calculating results to the stand-located equipment 10. As the stand-located equipment 10 receives the calculating results, it can display the waiting time for the next arriving taxi 5 (e.g., 5 minutes in FIG. 12) or the number of the arriving taxis (e.g., 3 taxis in FIG. 12) as shown in FIG. 12. This enables customers waiting for a taxi 5 to be notified of effective information.

Manner (6): The center-located equipment 2 notifies the discount information to open on the website on the Internet 8.

In this manner, the center-located equipment 2 opens the discount information on the website on the Internet 8 to notify as shown in FIG. 13 (Step 131 in FIG. 1). In addition, the points relative to the discount information can be edited to be blinked. This can visually highlight the discount information and expect effect.

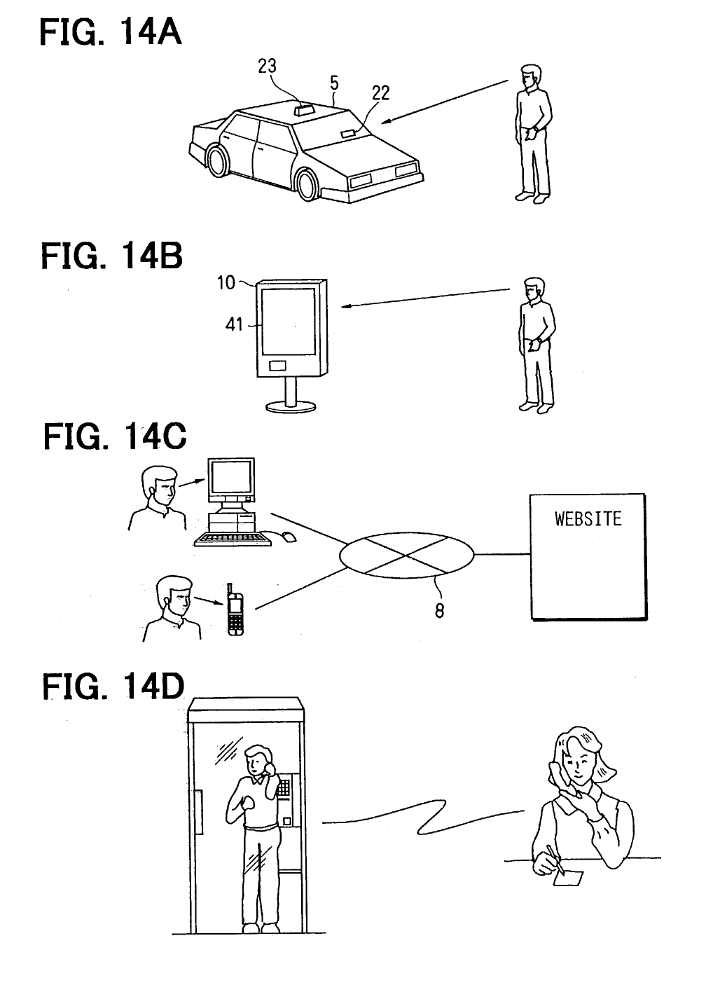

In brief, that the discount operation is executed are notified to the general public, as shown in FIGS. 14A to 14D, by the following:

(a) viewing ‘discount’ displayed on the interior or exterior sign of the taxi-located equipment 6;

(b) viewing ‘currently under discount operation’ on the display 41 of the stand-located equipment 6 installed in the stand 9;

(c) accessing the website opened on the Internet 8; and

(d) inquiring, using the communication devices such as a phone, an operator whether the discount operation is executed.

As the general public thus recognize the effect that the discount operation is executed, their intention of taking the taxis 5 is enhanced. This results in increase of the number of the customers.

On the other hand, the center-located equipment 2 cannot send the discount information to the taxi 5 when the taxi 5 stands or runs in an area where the taxi cannot use the NAW communication or the WAW communication. Some drivers of the taxis 5 therefore do not recognize that the discount operation is executed, while a customer who recognizes the discount information through accessing the website on the Internet 8. This may result in trouble due to recognition difference, between the taxi driver and the customer, whether the discount operation is executed.

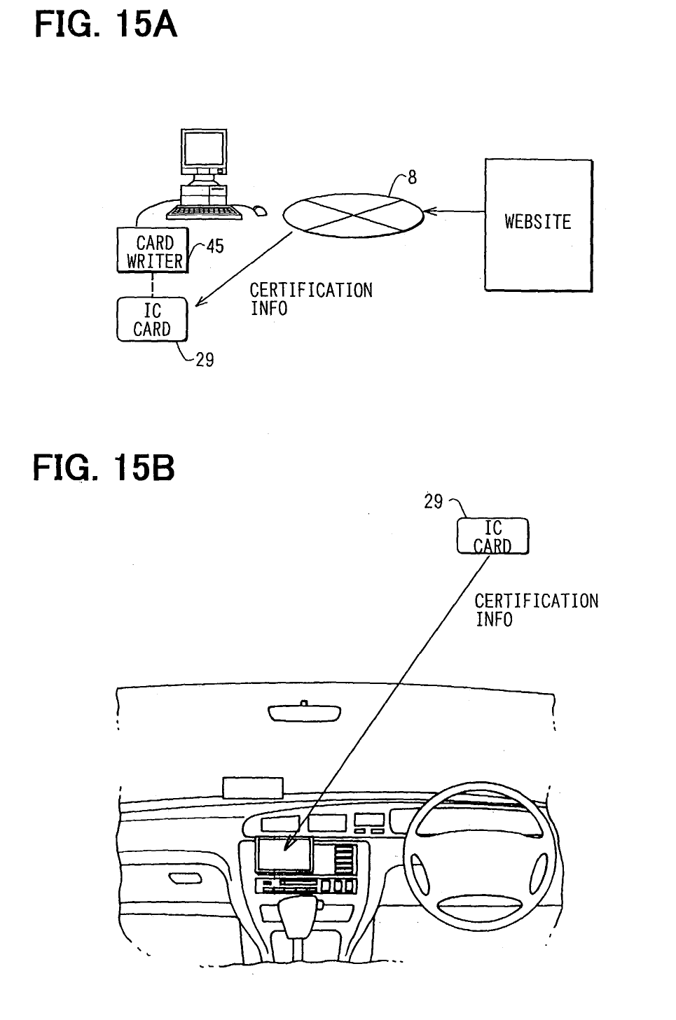

In the embodiment, as shown in FIGS. 15A and 15B, the trouble from the recognition difference is prevented by using the IC card 29 mentioned above. When the center-located equipment 2 opens the discount information on the website on the Internet 8, it grants, to the general public who accessed the website, the certification information for certificating that the website is accessed.

The certification information is granted as follows. When a card writer 45 is connected with a computer terminal through which the general public access the website, the certification information can be automatically stored in the IC card 29 inserted in the card writer 45. The certification information includes starting time when the discount operation is started. If the certification information is stored as an encoded information, the certification information is prevented from illicit storage by the general public. When a customer is going to take the taxi 5, he holds the IC card 29 that stores the certification information to submit to the driver of the taxi 5.

In the taxi-located equipment 6, as the IC card 29 that stores the certification information is inserted into the card reader 27, the stored certification information is read out and output to the control terminal 16. As the control terminal 16 receives the certification information, it authenticates the certification information. The authentication of the certification information is executed by collating it with reference information. If the collated certification information is rightly authenticated, an effect that the authentication is right is displayed on the display 25 by the control terminal 16. The driver thereby authenticates the certification information stored in the IC card 29.

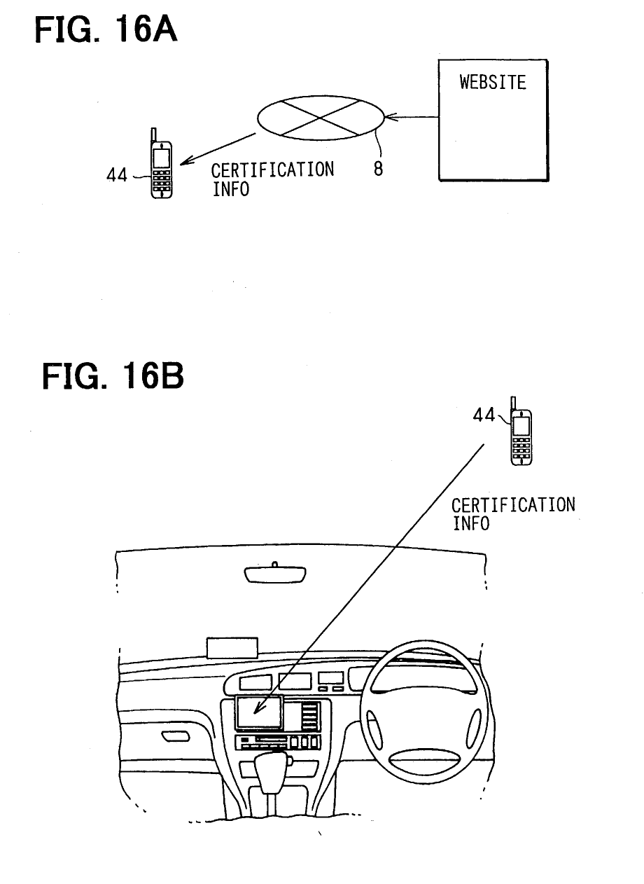

Media that stores the certification information can be not only the IC card 29 but also a cell phone 44 as shown in FIGS. 16A and 16B. Here, as the cell phone 44 accesses the website on the Internet 8, the certification information is stored in memory of the cell phone 44. The cell phone 44 then forwards the certification information to the taxi-located equipment 6 to be authenticated.

When a customer is notified that the discount operation is executed through inquiring, using the phone, the operator, the operator can notify a specific numeral or keyword comparable to the certification information to the customer. The customer thereby notifies the specific numeral or keyword to the driver of the taxi 5.

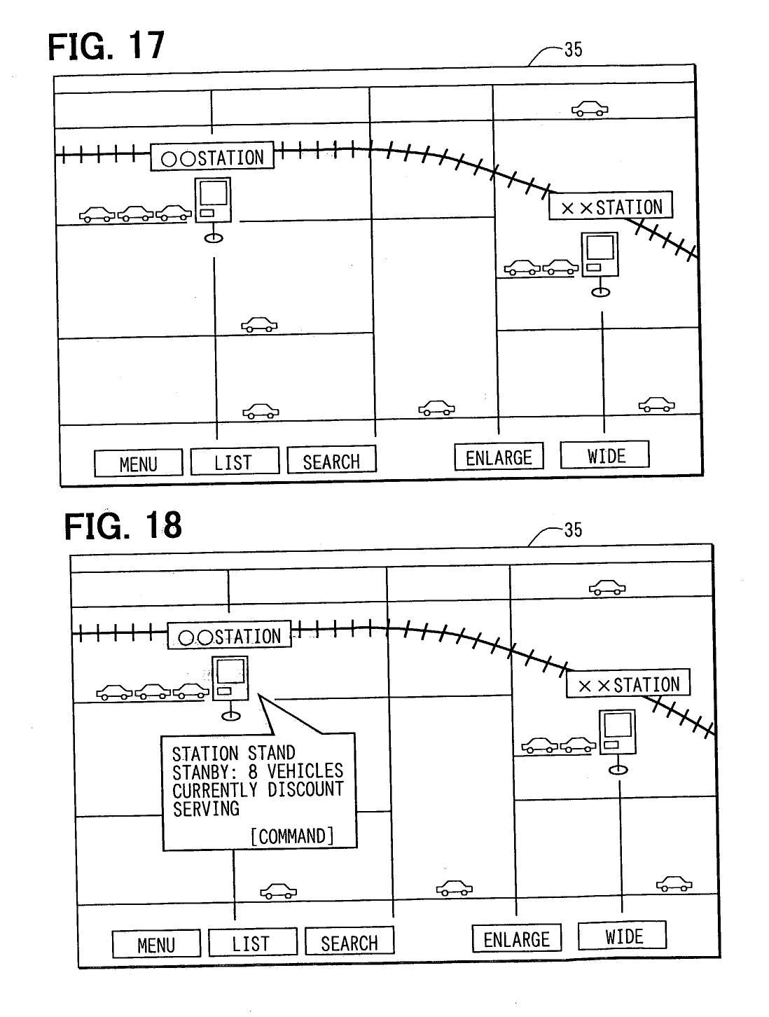

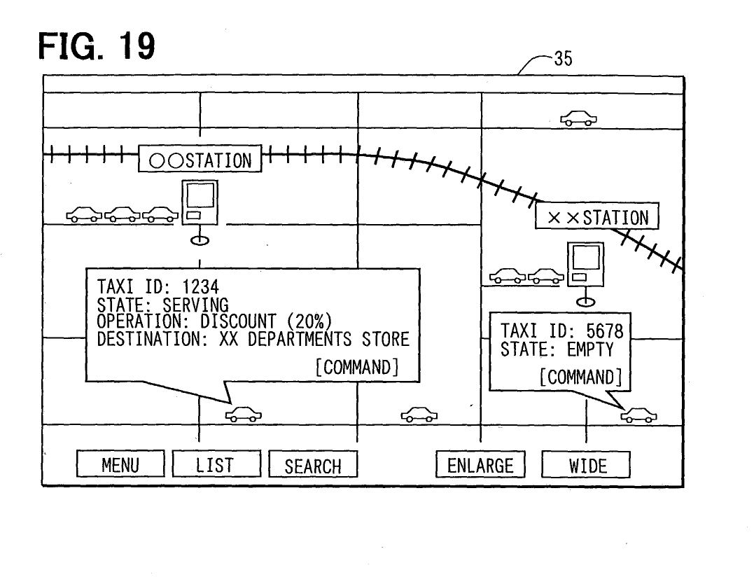

On the other hand, the center-located equipment 2 displays an operating state on the CRT 35, as shown in FIG. 17, as well as calculates the boarding ratio to determine whether the discount operation is executed. If an icon representing a stand 9 on the CRT 35 is clicked with a mouse 33, a state of the stand 9 such as the number of waiting taxis is displayed as shown in FIG. 18. If an icon representing a taxi 5 on the CRT 35 is clicked with the mouse 33, states of the taxi 5 such as an 5 operating state, an operation, and a destination are displayed as shown in FIG. 19. The center-located equipment 2 can recognize the number of waiting taxis 5 at the stand 9 to determine the discount ratio according to the recognized number of the waiting taxis 5.

When the discount operation is executed, the control terminal 16 in the taxi-located equipment 6 calculates the discounted fare to display on the interior sign 22 due to a circumstance where modification of the authorized taxi meter 20 is legally prohibited.

As explained above, that the boarding fare is reduced from the normal fare is notified to the general public who are not in the taxis 5. This enhances intention of the general public to want to take the taxi 5 and enables an operation company and a taxi driver to expect increase of customers. By contrast, the customers pay the reduced boarding fare and thereby obtain profit of reduction.

In addition, the certification information that the boarding fare is modified to be reduced from the normal fare is issued to a customer who is going to board the vehicle. Accordingly, even when a crewman does not recognize the reduction information that the boarding fare is modified to be reduced from the normal fare, the customer who is going to board the vehicle can, by submitting the issued certification information, resolve recognition difference with the crewman and prevent the trouble from the recognition difference.

The above embodiment of the present invention may be modified as follows.

The invention can be applied not only to the taxi business industry but also other business industries.

The operating state of the taxi can include ‘waiting’ or ‘rest’ in addition to ‘out-of-service,’ ‘empty,’ ‘pick-up,’ and ‘serving.’

The discount information can be notified not only by a visual method but also by an audio method such as a loudspeaker installed in the taxi or the stand. A speaker in the stand-located equipment can be also used for outputting the effect that the discount operation is executed.

By utilizing a radio wave beacon system, an optical beacon system, or an FM multiplex broadcast system, the center-located equipment can be provided to obtain traffic information or accident information from a vehicle information and communication system (VICS) center. The center-located equipment can thereby calculate to determine the discount ratio in consideration of the traffic information or the accident information.

The discount operation can be executed and terminated to return to the normal operation, regardless of the boarding ratio, according to preset starting and terminating time of the discount operation. Even if the boarding ratio becomes less than the reference boarding ratio, the normal operation can be continued until it reaches the preset starting time of the discount operation, and the discount operation can be started when it reaches the preset starting time of the discount operation. Here, the starting time of the discount operation can be set by the RF clock installed in the center-located equipment or the stand-located equipment. This enables the starting time of the discount operation to be accurately controlled in the whole system.

The discount operation can be done by a fixed reduction amount (e.g., a reduction amount per a distance unit) or a fixed boarding fare (e.g., a reduced boarding fare per a distance unit) in addition to the discount ratio.

The discount information such as ‘discount’ can be displayed on only either interior or exterior sign of the taxi.

When the taxi stands in the control center or the stand, the taxi can be prohibited from departing during the NAW communication.

The NAW control equipment and the roadside antennas can be installed, for instance, in an intersection where a number of the taxis run, in addition to the control center and the stand.

A navigation function can be combined to this embodiment, which enhances an added value of this service. While each taxi does not need to have each navigation system, the control center preferably has a totalized navigation system which can be utilized by each taxi as a client terminal through communication. This structure can suppress equipment investment.

What is claimed is:

1. A modification method of a boarding fare, of a plurality of vehicles, applied to a service industry where a customer pays the boarding fare for boarding one of the plurality of the vehicles, the method comprising steps of:
calculating boarding ratio based on the operating state information received from the plurality of the vehicle;
modifying to reduce the boarding fare from a normal fare when the boarding ratio becomes less than a predetermined ratio;
notifying reduction information expressing that the boarding fare is modified to be reduced from the normal fare to general public who are not in any of the plurality of the vehicles; and
executing reduction operation according to the modified boarding fare that is reduced from the normal fare.

2. A modification method of a boarding fare according to claim 1,
wherein the reduction information is notified to a crewman, and a customer who has already boarded in any of the plurality of the vehicles.

3. A modification method of a boarding fare according to claim 1,
wherein the reduction information is notified by being displayed on a display of equipment installed in any of the plurality of the vehicles.

4. A modification method of a boarding fare according to claim 1,
wherein the reduction information is notified by being displayed on a display of equipment installed in a waiting stand where a customer is waiting for the plurality of the vehicles to board.

5. A modification method of a boarding fare according to claim 1,
wherein the reduction information is notified by being opened on a website on the Internet.

6. A modification method of a boarding fare according to claim 1,
wherein the reduction information is notified by being displayed on a display of vehicle-located equipment installed in the plurality of the vehicles,
wherein the reduction information is notified by being displayed on a display of stand-located equipment installed in a waiting stand where a customer is waiting for the plurality of the vehicles to board,
wherein the boarding fare is modified to be reduced in center-located equipment installed in a control center, and
wherein the reduction information is notified by using at least either of Internet communication utilizing the Internet and wide area wireless communication utilizing wide area wireless communication equipment among the center-located equipment, the vehicle-located equipment, and the stand-located equipment.

7. A modification method of a boarding fare according to claim 6,
wherein the reduction information is notified by using narrow area wireless communication including dedicated short range communication (DSRC) between the center-located equipment and the vehicle-located equipment or between the stand-located equipment and the vehicle-located equipment.

8. A modification method of a boarding fare according to anyone of claims 1, further comprising a step of:
issuing certification information, which certificates the reduction information, to a customer who is going to board the plurality of the vehicles.

9. A modification method of a boarding fare according to claim 8, further comprising a step of:
authenticating the certification information, and
wherein when the certification information is rightly authenticated, the reduction operation is executed according to the modified boarding fare that is reduced from the normal fare.

10. A modification method of a boarding fare according to claim 1,
wherein the reduction information is notified together with at least one of a reduction ratio, a reduced fare, and a boarding fare.

11. A modification method of a boarding fare according to claim 1,
wherein the boarding fare decreases with increasing number of vehicles, of the plurality of the vehicles, which are waiting for a customer.

12. A modification system of a boarding fare, of a plurality of vehicles, applied to a service industry where a customer pays the boarding fare for boarding one of the plurality of the vehicles, the system comprising:
operating state obtaining means for obtaining operating state information from the plurality of the vehicles;
boarding ratio calculating means for calculating boarding ratio based on the operating state information obtained by the operating state obtaining means;
boarding fare modifying means for modifying to reduce the boarding fare from a normal fare when the boarding ratio becomes less than a predetermined ratio; and
reduction information notifying means for notifying reduction information, expressing that the boarding fare is modified to be reduced from the normal fare, to general public who are not in any of the plurality of the vehicles.

13. A modification system of a boarding fare according to claim 12,
wherein the reduction information notifying means notifies the reduction information to a crewman, and a customer who has already boarded in any of the plurality of the vehicles.

14. A modification system of a boarding fare according to claim 1,
wherein the reduction information notifying means notifies the reduction information by displaying the reduction information on a display of equipment installed in any of the plurality of the vehicles.

15. A modification system of a boarding fare according to claim 12,
wherein the reduction information notifying means notifies the reduction information by displaying the reduction information on a display of equipment installed in a waiting stand where a customer is waiting for one of the plurality of the vehicles to board.

16. A modification system of a boarding fare according to claim 12,
wherein the reduction information notifying means notifies the reduction information by opening the reduction information on a website on the Internet.

17. A modification system of a boarding fare according to claim 12,
wherein the reduction information notifying means notifies the reduction information by displaying the reduction information on a display of vehicle-located equipment installed in the plurality of the vehicles,
wherein the reduction information notifying means notifies the reduction information by displaying the reduction information on a display of stand-located equipment installed in a waiting stand where a customer is waiting for one of the plurality of the vehicles in order to board,
wherein the boarding fare modifying means is provided in center-located equipment installed in a control center, and
wherein the reduction information notifying means notifies the reduction information using at least either of Internet communication utilizing the Internet and wide area wireless communication utilizing wide area wireless communication equipment among the center-located equipment, the vehicle-located equipment, and the stand-located equipment.

18. A modification system of a boarding fare according to claim 17,
wherein the reduction information notifying means notifies the reduction information using narrow area wireless communication including dedicated short range communication (DSRC) between the center-located equipment and the vehicle-located equipment, or between the stand-located equipment and the vehicle-located equipment.

19. A modification system of a boarding fare according to claim 12, further comprising:
certification information storing means for storing certification information that certificates the reduction information.

20. A modification system of a boarding fare according to claim 19, further comprising:
certification information authenticating means for authenticating the certification information stored in the certification information storing means.

21. A modification system of a vehicle boarding fare according to claim 12,
wherein the reduction information notifying means notifies the reduction information together with at least one of a reduction ratio, a reduced fare, and a boarding fare.

22. A modification system of a boarding fare according to claim 12, further comprising:
waiting vehicle number recognizing means for recognizing the number of vehicles, of the plurality of the vehicles, that are waiting for a customer,
wherein the boarding fare modifying means modifies to decrease the boarding fare with increasing number of the vehicles, which are recognized by the waiting vehicle number recognizing means.

23. Vehicle-located equipment, provided in a vehicle within a system applied to a service industry where a customer pays a vehicle boarding fare for boarding the vehicle, used together with center-located equipment installed in a control center where boarding ratio is calculated based on operating state information that is received from the vehicle-located equipment and where the boarding fare is reduced from a normal fare when the boarding ratio becomes less than a predetermined ratio, the vehicle-located equipment comprising:
transmitting means for transmitting the operating state information to the center-located equipment;
receiving means for receiving, from the center-located equipment, reduction information expressing that the boarding fare is modified to be reduced from the normal fare; and
notifying means for notifying the received reduction information to a crewman, and a customer who has already boarded.

24. Stand-located equipment, provided in a waiting stand, where a customer is waiting for a vehicle to board, within a system applied to a service industry where a customer pays a vehicle boarding fare for boarding a vehicle, used together with center-located equipment installed in a control center where boarding ratio is calculated based on operating state information that is received from vehicle-located equipment installed in the vehicle and where the boarding fare is reduced from a normal fare when the boarding ratio becomes less than a predetermined ratio, the stand-located equipment comprising:
receiving means for receiving reduction information expressing that the boarding fare is modified to be reduced from the normal fare from the center-located equipment; and
notifying means for notifying the received reduction information to general public around the waiting stand.

25. Center-located equipment, provided in a control center within a system applied to a service industry where a customer pays a vehicle boarding fare for boarding a vehicle, the center-located equipment comprising:
receiving means for receiving operating state information from vehicle-located equipment installed in the vehicle;
calculating means for calculating boarding ratio based on the received operating state information;
modifying means for modify to reduce the boarding fare from a normal fare when the boarding ratio becomes less than a predetermined ratio; and
notifying means for notifying reduction information expressing that the boarding fare is modified to be reduced from the normal fare to the vehicle-located equipment and the stand-located equipment.

26. Center-located equipment according to claim 25, further comprising:
displaying means for displaying vehicle state and waiting stand state.
